(19) United States
(12) Patent Application Publication
(10) Pub. No.: US 2010/0307987 A1
(43) Pub. Date: Dec. 9, 2010

(54) APPARATUS AND METHOD FOR RECLAMATION OF TREATABLE WATER

(75) Inventors: Eric Neal Beaird, Cheynenne, OK (US); George Willis, Jal, NM (US)

Correspondence Address: MCAFEE & TAFT;TENTH FLOOR, TWO LEADERSHIP SQUARE, 211 NORTH ROBINSON, OKLAHOMA CITY, OK, 73102, US

(73) Assignee: H2O Cleaning Technologies, Cheyenne, OK (US)

(21) Appl. No.: 12/479,475

(22) Filed: Jun. 5, 2009

(51) Int. Cl. C02F 9/10; C02F 1/02

(52) U.S. Cl. 210/768; 210/774; 210/175

(57) ABSTRACT

The present invention relates to an apparatus and method to reclaim water. The water that may be reclaimed begins as untreated treatable water, which is water having solids, particulates, or minerals not originally in the water. Untreated treatable water is also natural water having solids, particulates, or minerals that are undesired. The invention provides for removal of the totally dissolved solids from the water by micronizing the water in a chamber having a first temperature, and condensing the water in a second chamber having an interior surface that is cooled to the ambient wet-bulb temperature of the surrounding environment. Reclaimed treatable water from this invention becomes usable water.

### BACKGROUND OF THE INVENTION

Usable water is critical for manufacturing, production, agriculture and numerous other activities that use or require water. Due to naturally occurring pollutants, man-made pollutants and other factors, the volume of usable water is decreasing throughout the world. The lack of usable water drives the need to reclaim polluted water into usable water. Thus, a challenge for all water users is how to reclaim polluted water as usable water for commercial and other operations.

Water can be polluted in numerous ways by either man or nature. Man-made pollutants can be directly generated during the use of the water. Man-made pollutants can also be indirectly generated as a by-product of other activities. For example, construction and agriculture are sources of indirectly generated water pollutants. Naturally occurring pollutants, such as salts and/or metals, generate polluted water when there is runoff from watersheds into streams, rivers, lakes and aquifers. Additionally, naturally occurring pollutants may generate polluted water by leaching from the soil into aquifers.

Once water is polluted, it is an environmental problem and therefore requires safe and proper disposal. Unfortunately, it can be difficult to dispose of polluted water in a safe manner.

The most common method to dispose of polluted water is to inject the water into disposal wells. This method is used by different industries, including the oil and gas industry. However, current and proposed environmental regulations are limiting the use of disposal wells because some of these wells fail to prevent the polluted water from leaching into the water table. Thus, there are fewer locations in which polluted water can be injected into disposal wells.

Within the oil and gas industry, polluted water is generated in several ways. Typically, the largest volume of polluted water is generated during the drilling phase of the oil or gas product. During the drilling phase, usable water is needed to make the drilling mud flow. However, the combination of the drilling mud, usable water, and drilling cuttings creates polluted water.

Most polluted water is actually treatable water. In many cases, the polluted water is referred to as untreated treatable water. Some of the polluted water may have as high as 10% by weight of solids in suspension, based on the total weight of the water, and dissolved solids as high as 20% or more by weight, based on the total weight of the water. Other polluted waters may contain enough solid, particulate, or mineral mass to be near saturation capacity. Many of these solids, particulates, and minerals are valuable materials having a value apart from the water.

Usable water is also harder to find today due to drought, overuse, agriculture, pollution and community needs. As a result, governmental bodies at all levels are enacting water plans designed to protect their immediate and future needs, thereby further restricting the acquisition of usable water. These actions significantly impact all industries needing water to operate.

By treating the polluted water, disposing of the water becomes unnecessary or less complex. If disposal is necessary, it is easier to do when the water is treated. Treating the polluted water also makes more water readily available for other uses while protecting the environment.

Because reclamation of polluted water is highly desirable, the need for affordable reclamation processes and devices exists. Unfortunately, the current techniques available for reclaiming polluted water are expensive, and they are difficult to use in remote settings. Most reclamation processes of polluted water involve building a significant infrastructure having multiple steps/phases.

A need exists for an apparatus and method that efficiently and economically reclaims polluted water both remotely and in fixed locations.

### SUMMARY OF THE INVENTION

The invention provides an apparatus and method for reclaiming untreated treatable water.

In one aspect, the invention is a method for removing solids from water carrying a plurality of solid particles, wherein the solid particles include suspended solids and dissolved solids. The inventive method comprises the steps of:
a. transferring the water to a first separator;
b. separating suspended solids from the water using the first separator;
c. transferring the water from the first separator into a first chamber having an interior temperature greater than the ambient wet-bulb temperature and below the boiling temperature of the water, the first chamber being in fluid communication with a second chamber having a similar shape and size as the first chamber;
d. prior to or concurrently with the step of transferring the water from the first separator to the first chamber, reducing the particle size of the water particles such that the water particles have a mean particle size of about 100 microns or less; and
e. allowing substantially all of the dissolved solids in the water to separate from the water in the first chamber.

In another aspect, the invention is a method for reclaiming a treatable water having dissolved solids. The inventive method comprises the steps of:
a. providing a first chamber having an interior temperature greater than the ambient wet-bulb temperature of the surrounding environment and less than the boiling temperature of the water, the first chamber being unpressurized;
b. providing a second chamber, the second chamber being in fluid communication with the first chamber and having a similar shape and size as the first chamber;
c. cooling an interior surface positioned within the second chamber to the ambient wet-bulb temperature of the surrounding environment, thereby creating a temperature differential between the first chamber and the cooled interior surface;
d. injecting the treatable water into the first chamber, the treatable water carrying at least one dissolved solid;
c. prior to or concurrently with the step of injecting the treatable water into the first chamber, micronizing the treatable water to a water particle size having a micronized mean particle diameter of about 100 microns or less, wherein the step of micronizing separates the dissolved solid from the water particle and creates a fog of the micronized water particles in the first chamber;
f. transferring the fog from the first chamber to the second chamber;
g. condensing the fog into a condensate of reclaimed water on the interior surface within the second chamber;
h. collecting the reclaimed water within the second chamber; and
i. extracting the reclaimed water from the second chamber.

In another aspect, the invention is an apparatus for water reclamation. The inventive apparatus includes a first and a second chamber, the first and second chambers being in fluid communication with each other. The first and second chambers are unpressurized and substantially similar in shape and size. A micronizer is positioned within the first chamber. The micronizer is suitable for injecting the water into the first chamber and creating a fog in the first chamber. A heat exchanger system is positioned within the second chamber and is suitable for condensing the fog transferred from the first chamber to the second chamber.

In another aspect, the invention is a portable water reclamation apparatus for water having dissolved solids. The apparatus includes a skid, a first and second chamber, a plurality of injectors and a cooling system. The first and second chambers are mounted upon the skid. The first and second chambers are unpressurized and have a substantially similar shape and size. The injectors are in fluid communication with the first chamber, providing water thereto. The second chamber is in fluid communication with the first chamber. The cooling system is associated with the second chamber and operably cools an interior surface of the second chamber temperature to the ambient wet-bulb temperature of the surrounding environment.

In another aspect, the invention is an apparatus for removing dissolved solids from water. The inventive apparatus includes a first chamber, a plurality of micronizers, a heating system, a second chamber, and a cooling system. The micronizers are positioned on the first chamber and are capable of injecting the water into the first chamber. The micronizers reduce the water particles to micronized water particles having a mean diameter of about 100 microns or less. The heating system is operably associated with the first chamber and increases the interior temperature of the first chamber to greater than the ambient wet-bulb temperature of the surrounding environment, and less than the boiling temperature of water. The second chamber has a substantially similar shape and size as the first chamber and is in fluid communication with the first chamber. The cooling system is operably associated with the second chamber and is suitable for cooling an interior surface within the second chamber to the ambient wet-bulb temperature of the surrounding environment.

Numerous objects and advantages of the invention will become apparent as the following detailed description of the preferred embodiments is read in conjunction with the drawings which illustrate such embodiments.

### BRIEF DESCRIPTION OF THE DRAWINGS

FIG. 1 depicts a schematic of a complete water reclamation system.

FIG. 2 depicts a schematic perspective view of the apparatus with a plenum.

FIG. 3 depicts a schematic side view of the apparatus with a plenum.

FIG. 4A depicts a schematic top view of the first chamber.

FIG. 4B depicts a schematic sectional top view of the first chamber with the first heat exchanger.

FIG. 5A depicts a schematic top view of the second chamber.

FIG. 5B depicts a schematic sectional top view of the second chamber with the second heat exchanger.

FIG. 5C depicts a schematic sectional top view of the second chamber with the second heat exchanger positioned in an alternative configuration.

FIG. 6A depicts a schematic elevational view of the apparatus with a plenum, first heat exchanger system, second heat exchanger system and chillers.

FIG. 6B depicts a schematic elevational view of the apparatus with a vessel, first heat exchanger system, second heat exchanger system and chillers.

FIG. 6C depicts a schematic elevational sectional view of the apparatus with a vessel, first heat exchanger system, and second heat exchanger system.

FIG. 7A depicts a schematic perspective view of a condensation tube bank.

FIG. 7B depicts a schematic perspective view of a heat tube.

FIG. 8 depicts a schematic end view of the plenum connected to the second chamber.

FIG. 9 depicts a schematic perspective view of the inventive apparatus mounted on a skid.

FIG. 10 depicts a schematic view of a micronizer injecting a fog.

FIG. 11 depicts a schematic elevation view of a header for a micronizer.

### DETAILED DESCRIPTION

As used herein, the term “dissolved solid” refers to a solution comprising a liquid with a solid dissolved therein. The term “untreated treatable water” refers to polluted water containing dissolved solids or liquids and/or a suspension of solids or liquids. The terms “mean diameter,” “mean size,” “mean particle diameter” and “mean particle size” refer to an average diameter or size of a particle. The term “boiling temperature” refers to the temperature for a given altitude and a given atmospheric pressure that will boil water. The term “ambient wet-bulb temperature” refers to a temperature of the environment surrounding the apparatus and measured by a wet-bulb thermometer.

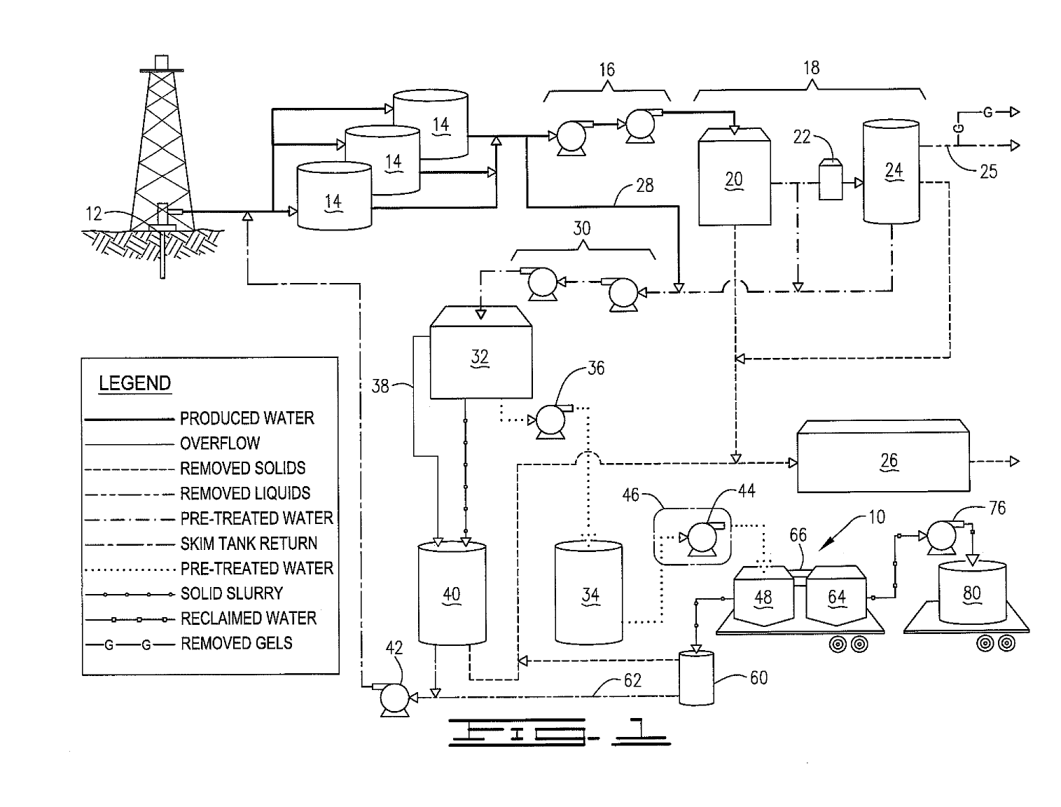

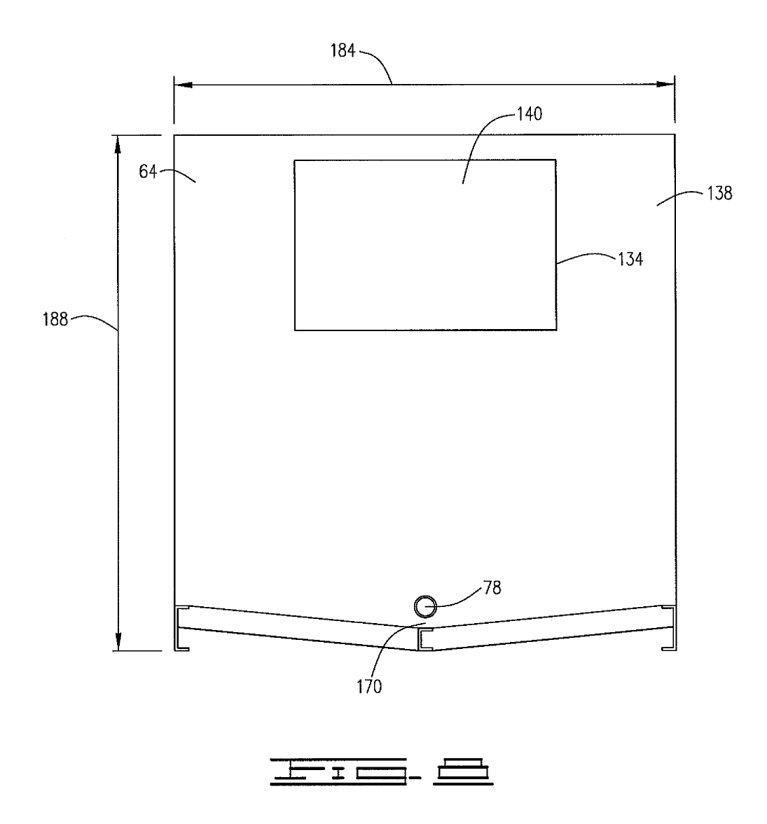

Referring to the drawings and specifically to FIGS. 1-11, the condensation apparatus is illustrated and generally designated by the numeral 10. As shown by the drawings and understood by those skilled in the art, condensation apparatus 10 and components thereof are designed to be associated with treatable water, the pre-treatment of treatable water, and the processing of the pre-treated water.

### Concept of Operations

The depiction in FIG. 1 provides the concept of operations for a notional system providing untreated treatable water from an oil well site. Other sources of untreated treatable water, such as ground water, factories, sugar refineries, etc., can also use this process. Additionally, naturally occurring water, such as naturally polluted aquifers, brackish water, sea water, or briny water may also be subjected to this process. In these cases, the untreated treatable water may have solid matter suspended in it, such as soils, salts, metals, minerals, hydrogen sulfide, gels, and petroleum hydrocarbons.

In the concept of operations for the notional system, an oil well is the source of untreated treatable water 12. Untreated treatable water 12 has suspended solids, suspended liquids, and dissolved solids. Untreated treatable water 12 is communicated from the source of untreated treatable water 12 to holding tank 14.

FIG. 1 depicts pump 16 communicating the untreated treatable water 12 from holding tank 14 to the suspended solid and liquid separation system 18, where the suspended solids and/or liquids are separated. Pump 16 may be a single pump or a plurality of pumps. In the notional system, pump 16 is a positive cavitation pump designed to prevent further mixing and/or dissolving of the solids and liquids in untreated treatable water 12

Separation system 18 is depicted with first separator 20, heater 22, and second separator 24. First separator 20 is a horizontal centrifuge for gravitationally separating the solids. If hydrocarbons are present, heater 22 is utilized prior to communicating the water to second separator 24. Second separator 24 has at least one vertical centrifuge for gravitationally separating the suspended liquids. Suspended liquids are separated within second separator 24. The separated liquids, including gels, are removed through line 25 for further treatment, recycling or reuse. The solids removed from first separator 20 are communicated to a dryer 26. Additional solids from second separator 24 are also communicated to dryer 26 for additional processing. FIG. 1 depicts a microwave dryer, but any dryer suitable for receiving solids from first separator 20 and second separator 24 will suffice.

As an alternative to using separation system 18, bypass 28 is utilized to communicate untreated treatable water 12 directly to pump 30 when there are minimal, or no suspended solids and/or liquids entrained within untreated treatable water 12. Bypass 28 provides fluid communication between holding tank 14 and pump 30.

At this point in the process, substantially all of the suspended solids and liquids have been removed, and the untreated treatable water 12 is now referred to as pre-treated water. Pre-treated water typically has some level of total dissolved solids (TDS) remaining as a solution that still require removal for reclamation of the water.

Even though the pre-treated water is substantially free of suspended solids, additional micro-filtration may be utilized, and/or desired. FIG. 1 depicts pump 30 communicating the pre-treated water to an optional filter system 32. Pump 30 may be a single pump or a plurality of pumps. Filter system 32 is preferably used to ensure that any micro particles are further removed prior to the separation of the dissolved solids. In cases where the pre-treated water has fewer suspended solids, filter system 32 is not used, and the pre-treated water is directly communicated to condensation apparatus 10.

When filter system 32 is utilized, the pre-treated water exiting filter system 32 is substantially free of suspended particles. The pre-treated water is communicated from filter system 32 to pre-treated water storage tank 34 by pump 36. During the process, if too much of the pre-treated water is present in filter system 32, it is removed by overage tube 38, which communicates the excess pre-treated water to skim tank 40. Any separated solids are communicated from filter system 32 to skim tank 40. Pre-treated water in skim tank 40 may be pumped back to holding tank 14 with pump 42. Water from skim tank 40 is removed from the top, and solids are removed from the bottom. The removed solids are further communicated to dryer 26.

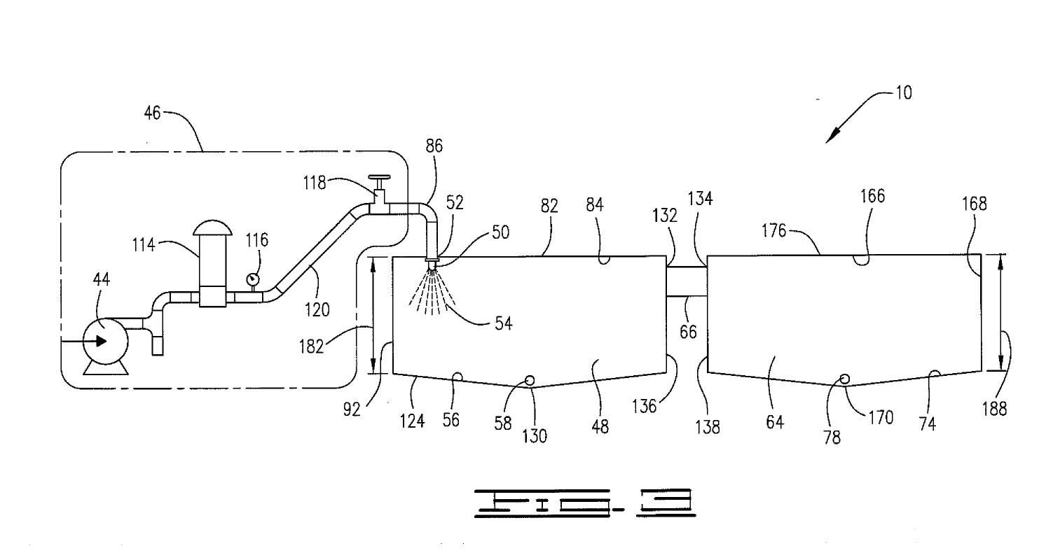

Pump 44 is part of pressurization system 46 communicating the pre-treated water to first chamber 48 of condensation apparatus 10. Pressurization system 46 communicates the pre-treated water to first chamber 48. Pressurization system 46 is depicted in FIGS. 1 and 3.

In the concept of operations, the communication of the pre-treated water to a device associated with first chamber 48 reduces the water particles to a mean particle size of about 100 microns or less. Preferably, the water particles are reduced to a mean particle size of about 50 microns or less. By reducing the water particles to a mean particle size, it is easier to break the bond between the dissolved solid and the water particle, and thus, reclaim water.

In the preferred embodiment, the device reducing the mean particle size is micronizer 50. Micronizer 50 is positioned within injector port 52 to create a vapor cloud, or fog 54, within first chamber 48, also called the micronizing chamber. Alternatively, the mean particle size of the water particles may be reduced using other technologies such as a venturi injector and air, a kinetic impact device, or some other device capable of reducing the mean particle size of the water particles down to about 100 microns or less.

Breaking the bond between the water particle and the dissolved solid includes the temperature of the environment where the particle of water is reduced in size. The desired interior temperature of first chamber 48 is greater than the ambient wet-bulb temperature of the surrounding environment and less than the boiling temperature for water, or about 212° F. (100° C.). The desired interior temperature of first chamber 48 does not reach or exceed the boiling point of the water being injected. Preferably, the desired temperature range is between about 100° F. (37° C.) to about 150° F. (66° C.). In the preferred embodiment, the desired interior temperature of first chamber 48 is achieved using heat exchanger 122 having heat tubes 126. Alternatively, the interior temperature of first chamber 48 may be achieved by using microwave energy, solar energy, ambient temperature, or other similar devices or techniques. Additionally, the alternative heating approach may include the use of parasitic heat from other sources, such as waste heat from another source.

The combination of the small particle size with the temperature within first chamber 48 causes the bond between the dissolved solid and the water particle to break. Almost all types of bonds between the dissolved solid and the water particle may be broken by this process. For example, condensation apparatus 10 will break chemical bonds. During the bond breaking process, water particles form fog 54, and the solid particles fall to floor 56 of first chamber 48. The separated solid particles combine with some of the water to form a slurry that is extracted through port 58 positioned near floor 56 of first chamber 48. The slurry is removed to slurry tank 60. From slurry tank 60, the pre-treated water is communicated to pump 42 through flow-back line 62. The pre-treated water is further communicated to holding tank 14, where it may be recycled through the entire process. The solids are communicated from slurry tank 60 to dryer 26.

To reclaim the water, fog 54 must be condensed. FIG. 1 depicts an embodiment utilizing condensation apparatus 10 having first chamber 48 and second chamber 64 with plenum 66 providing fluid communication therebetween. In that embodiment, second chamber 64 is utilized to condense the water from fog 54. The condensation apparatus 10, depicted in FIG. 1, provides for the transfer of fog 54 from first chamber 48 to second chamber 64 by a natural convective flow. This is accomplished by lowering an interior surface 68 temperature of second chamber 64 to the wet-bulb dew point temperature of the surrounding environment. In one embodiment, the interior surface temperature is achieved using an internally positioned heat exchanger 142. This temperature may be achieved through refrigerated cooling, ambient air cooling, or other common cooling techniques.

Alternatively, the process does not require natural convective flow through plenum 66 for transferring fog 54 to second chamber 64 for condensation. Other techniques, known to those skilled in the art, will provide the function of transferring fog 54. For example, a fan (not shown) will transfer fog 54 from first chamber 48 to second chamber 64 without relying upon natural convective flow.

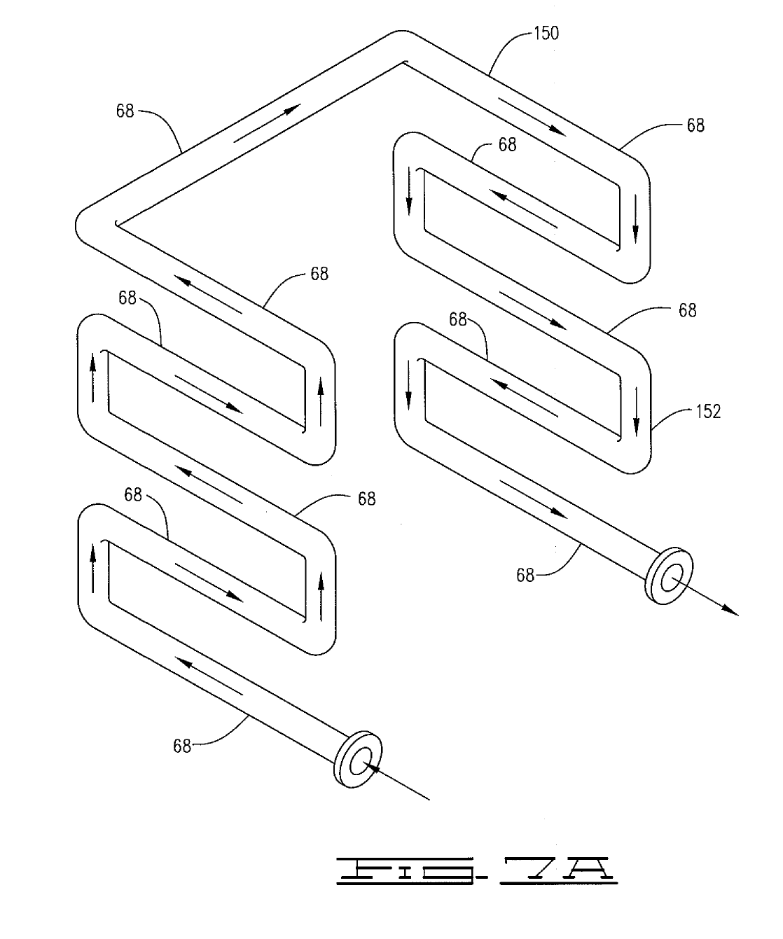

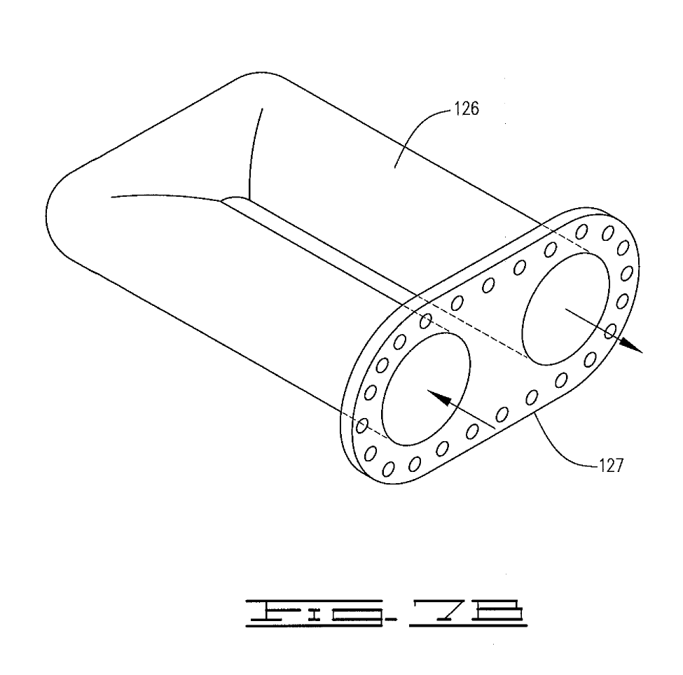

FIGS. 6B-6C depict an embodiment where condensation apparatus 10 does not utilize plenum 66. Instead, first chamber 48 and second chamber 64 are combined to form vessel 70. Vessel 70 has separation wall 72 positioned between first chamber 48 and second chamber 64 and has a sufficient height to ensure the slurry does not mix with the reclaimed water.

The water in second chamber 64 that condenses on the interior surfaces 68 of second chamber 64 is reclaimed water. The majority of the condensed, reclaimed water falls or flows to floor 74 of second chamber 64. Pump 76 communicates the reclaimed water from second chamber 64 through port 78 to holding tank 80. Port 78 is located near floor 74. However, it is also possible that pump 76 is not used, and the reclaimed water is gravitationally communicated to holding tank 80 or a disposal well (not shown) by the force of gravity.

The test results show the level of reclamation is dependent upon the TDS found in the pre-treated water. This process reduces the TDS in the water to a range between about 40% and about 99%, with a preferred reduction of TDS being in the range between about 80% and about 98%. Once reclaimed the water has become usable water ready for disposal or reuse.

### Apparatus

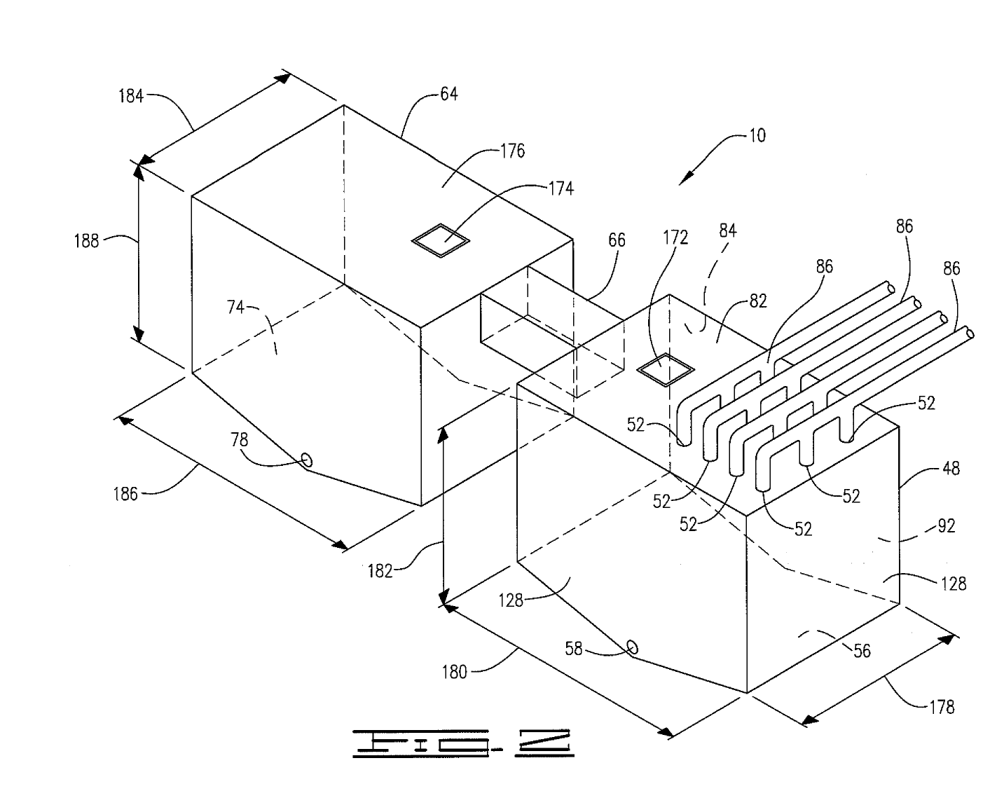

Referring to FIGS. 2-11, condensation apparatus 10 is shown in detail with first chamber 48 and second chamber 64. Second chamber 64 is preferably substantially similar to first chamber 48 in both size and shape. In one embodiment, first chamber 48 is connected to second chamber 64 by plenum 66. In another embodiment, first chamber 48 and second chamber 64 form vessel 70, which operates without plenum 66, but utilizes separation wall 72.

Regarding FIGS. 2-4A and 9, injector ports 52 are positioned across chamber top 82 and disposed therethrough. Preferably, a plurality of injector ports 52 are positioned on chamber top 82, near ceiling 84 with micronizers 50 disposed therein. Although injector ports 52 are positioned on chamber top 82, they may be positioned anywhere on first chamber 48 that allow micronizer 50 positioned within chamber 48 for creating fog 54 within first chamber 48. If a plurality of injector ports 52 are utilized, a plurality of micronizers 50 are used, and header 86 is preferably employed to distribute the pre-treated water to all micronizers 50.

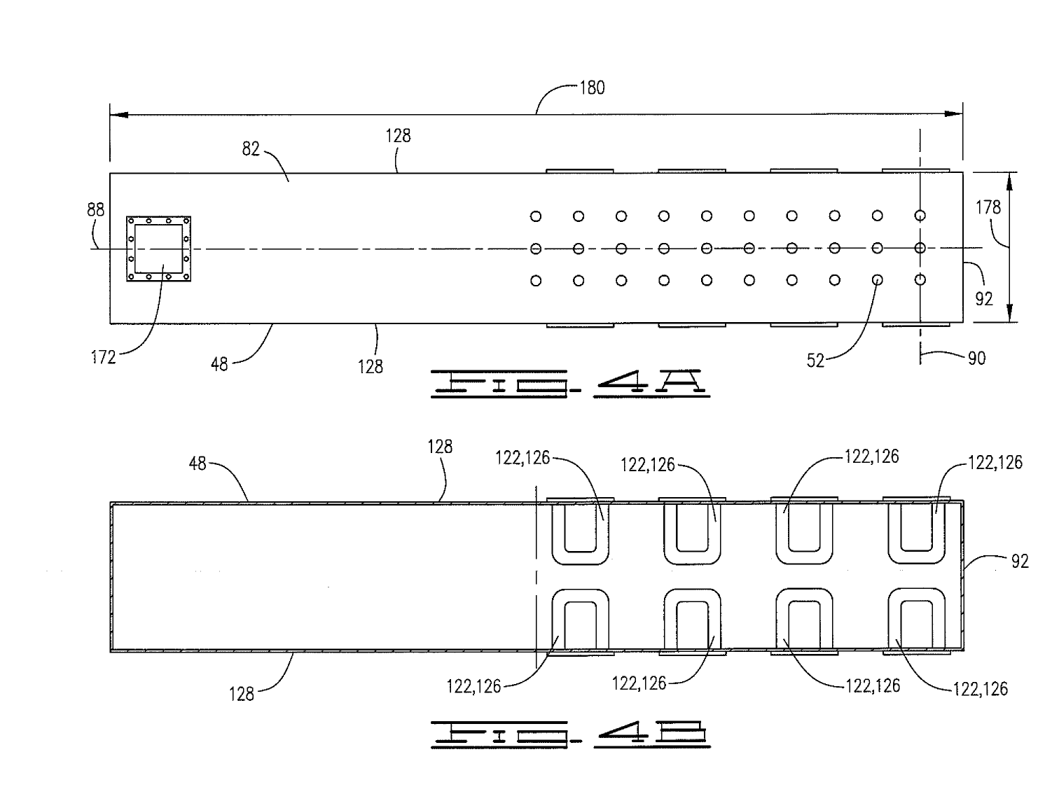

FIG. 4 depicts one embodiment utilizing an array of about 30 injector ports 52 aligned in 3 rows of 10. In this embodiment, the center row is depicted as being aligned along center line 88 of first chamber 48. Each of the injector ports are positioned about 2 feet (0.61 meters) apart longitudinally and latitudinally. First row 90 is positioned about 8 inches (0.2 meters) to about 3 feet (0.91 meters) from outer edge 92 of first chamber 48. The preferred embodiment utilizes about one-half of the length 180 of first chamber 48 to position injector ports 52. The number of injector ports 52 are evenly spaced based upon the coverage of fog 54 produced by micronizers 50 within first chamber 48. The remaining one-half of first chamber 48 is used to allow the separated solids to fall to floor 56 of first chamber 48.

Referring to FIGS. 2, 3 and 11, header 86 provides fluid communication between pressurization system 46 and micronizers 50. Header 86 has a plurality of T-joints 94 with nipples 96 connected thereto. Tube 98, reducer 100, nipple 102, and protective nipple 104 provide fluid communication between header 86 and micronizers 50. Tube 98 is connected to nipple 96 with first hammer union 106. Tube 98 is either welded or threadedly engaged with reducer 100. Reducer 100 is either welded or threadedly engaged with nipple 102. Micronizer nipple 108 is secured within nipple 102 using mounting inserts 110. Mounting inserts 110 are securely positioned within nipple 102 using techniques known to those in the art. Micronizer nipple 108 may be welded or threadedly engaged with mounting inserts 110. Protective nipple 104 is secured to chamber top 82 at injector port 52 by welding or other techniques securely positioning it within injector port 52. Protective nipple 104 is connected to nipple 102 using second hammer union 112. Micronizer 50 is threadedly engaged with micronizer nipple 108, which provides fluid communication to micronizer 50. This configuration is duplicated for each injector port 52 and micronizer 50.

The pressurization system 46 and header 86 communicate pre-treated water to micronizers 50, as depicted in FIG. 3. Pressurization system 46 includes pump 44, pressure chamber 114, pressure gauge 116, and flow valve 118. Pressurization system 46 is fluidly connected by piping 120. It is preferred that pump 44 be able to produce a flow of water at a pressure of at least 1000 pounds per square inch (psi) (6895 kilopascal).

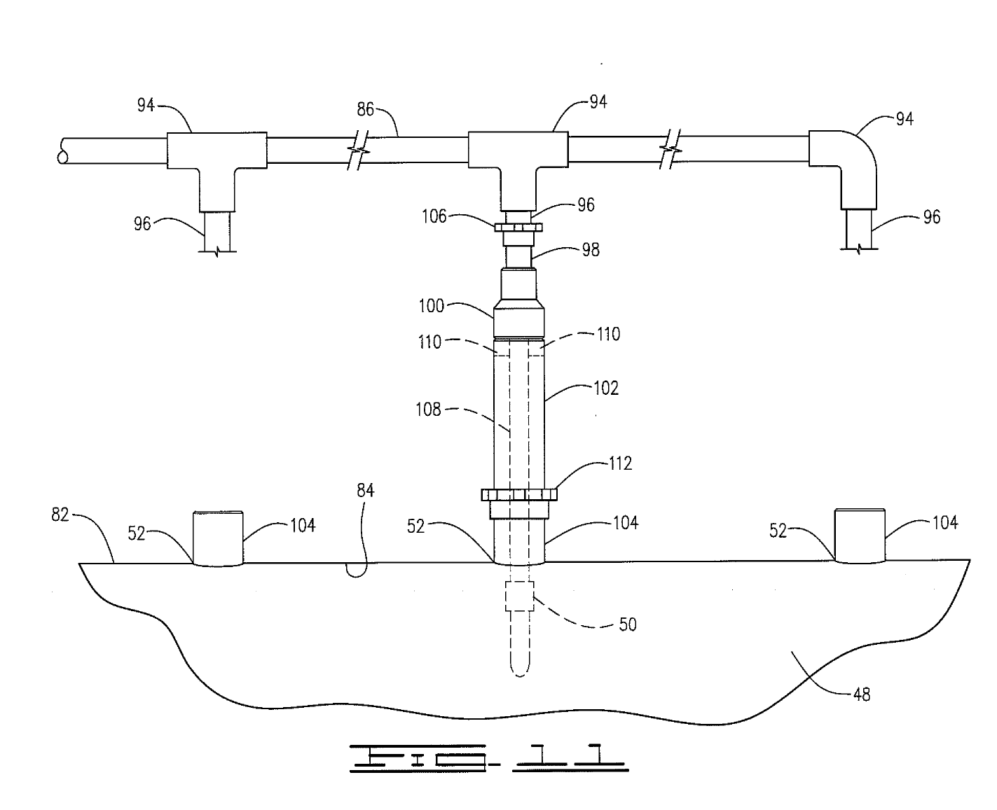

Preferably, micronizers 50 create fog 54, as depicted in FIGS. 3 and 10. Micronizer 50 is capable of reducing the water particle to a mean particle size of about 100 microns or less. Preferably, micronizer 50 is capable of reducing the water particle to a mean particle size of about 50 microns or less.

First chamber 48 is actively heated using a preferred heat exchanger system 122 that provides for indirect, self-contained heating. Heat exchanger system 122 is depicted in FIGS. 4A, 4B, 6A-6C and 7B as being about 12 inches (0.3 meters) above chamber bottom 124 of first chamber 48. As depicted, heat exchanger system includes heat tubes 126 mounted to chamber side wall 128 with tube flange 127. Heat tubes 126 are suitably adapted to receive heat from a heat source through external pipes 131, and conduct that heat through heat tube 126. The conducted heat causes heat tubes 126 to radiate heat within first chamber 48, thereby controlling the interior temperature of first chamber 48 within a desired temperature range. A non-limiting example of a heat source is waste gas from a well site that produces sufficient heat. Alternatively, first chamber 48 may be passively heated using other means known to the industry, such as solar energy or ambient air.

Heat exchanger system 122 is a heating system having the heating capacity capable of raising and maintaining the interior temperature of first chamber 48 to a desired temperature range. The desired temperature range is greater than the ambient wet-bulb temperature of the surrounding environment, and less than the boiling temperature of water, or about 212° F. (100° C.) at sea level. Preferably, the desired temperature range is between about 100° F. (37° C.) to about 150° F. (66° C.). Testing of condensation apparatus 10 shows good results when heat exchanger system 122 maintains the interior temperature of first chamber 48 to a range between about 140° F. (60° C.) to about 150° F. (66° C.). The interior temperature of first chamber 48 is measured by an internally positioned thermometer (not shown).

Port 58 is positioned at a low point of chamber 48 for the removal of the slurry that forms therein. FIGS. 2 and 3 depict first chamber floor 56 having a slight slope. Port 58 is positioned at lowest point 130 of the slope.

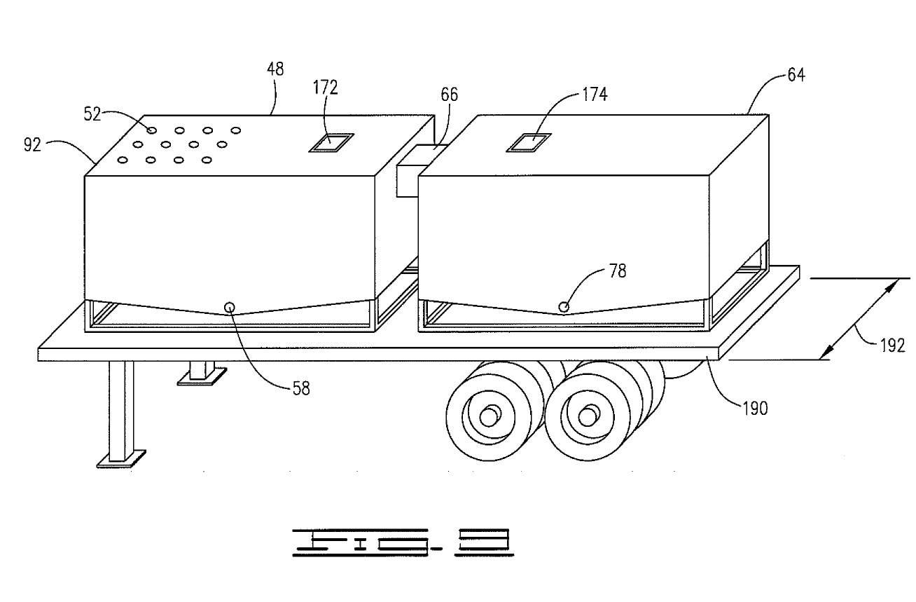

Referring to FIGS. 2, 3, 6A, 8 and 9, plenum 66 has first end 132 and second end 134. First end 132 is connected to first chamber wall 136, and second end 134 is connected to second chamber wall 138. FIG. 8 shows a cross-sectional area 140 of plenum 66 connected to second chamber 64. Preferably, cross-sectional area 140 is uniform between first end 132 and second end 134.

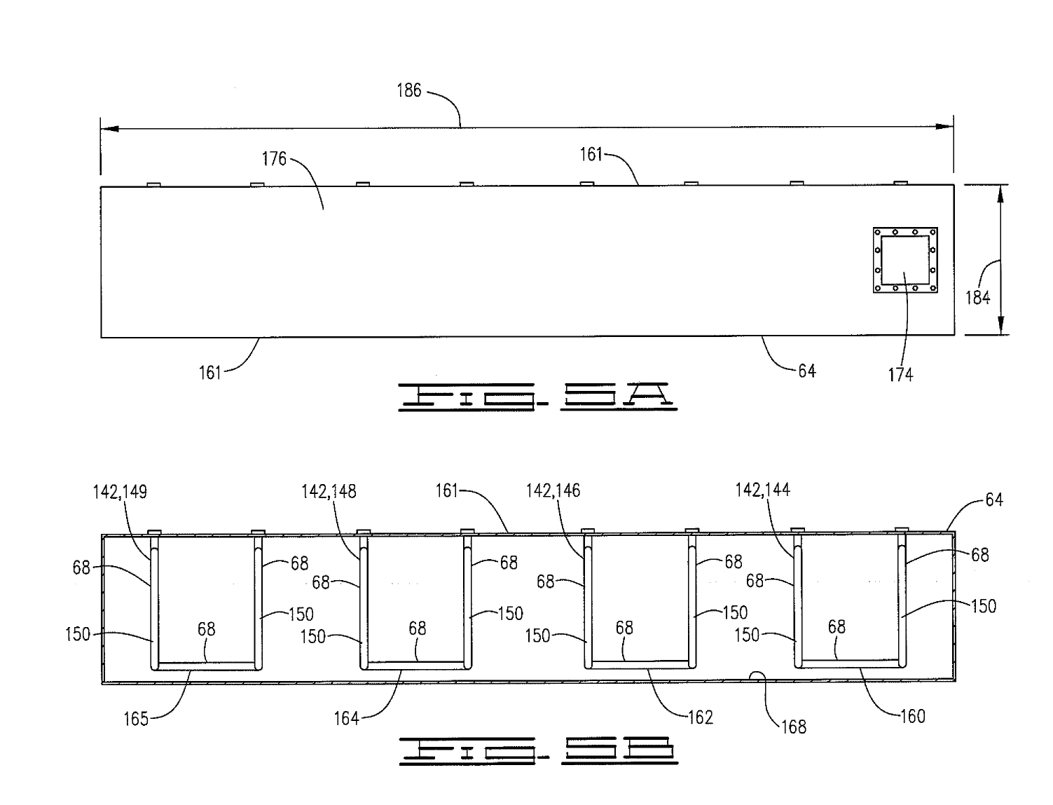

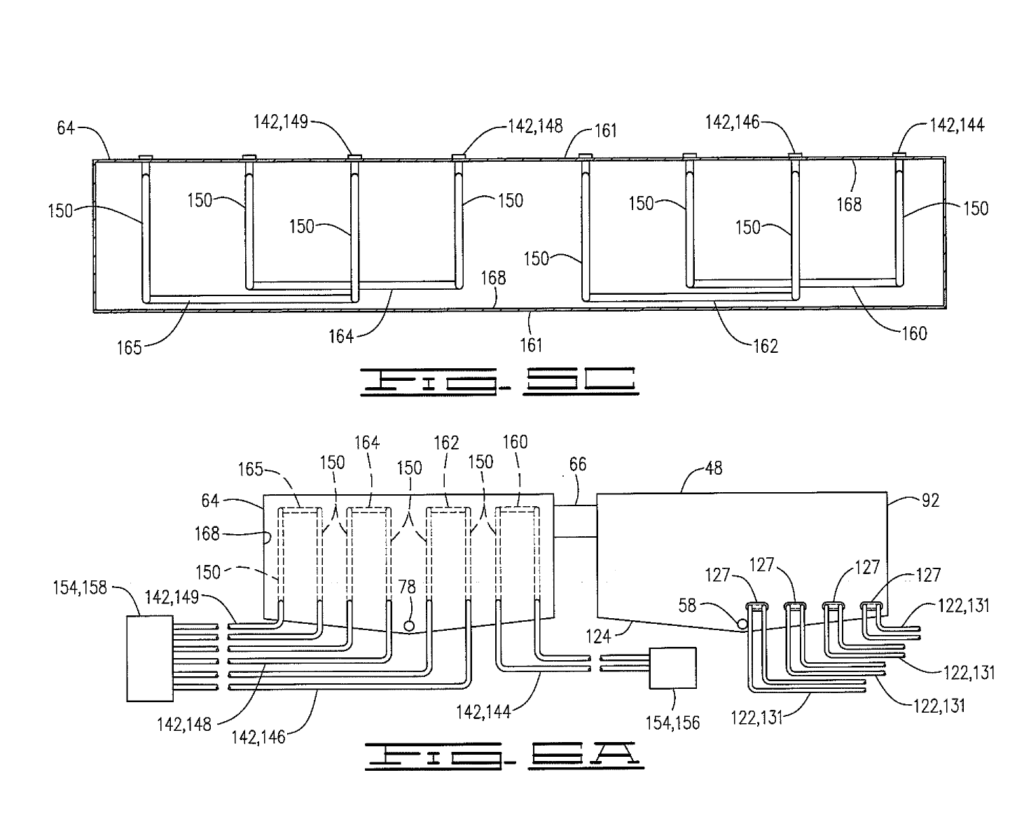

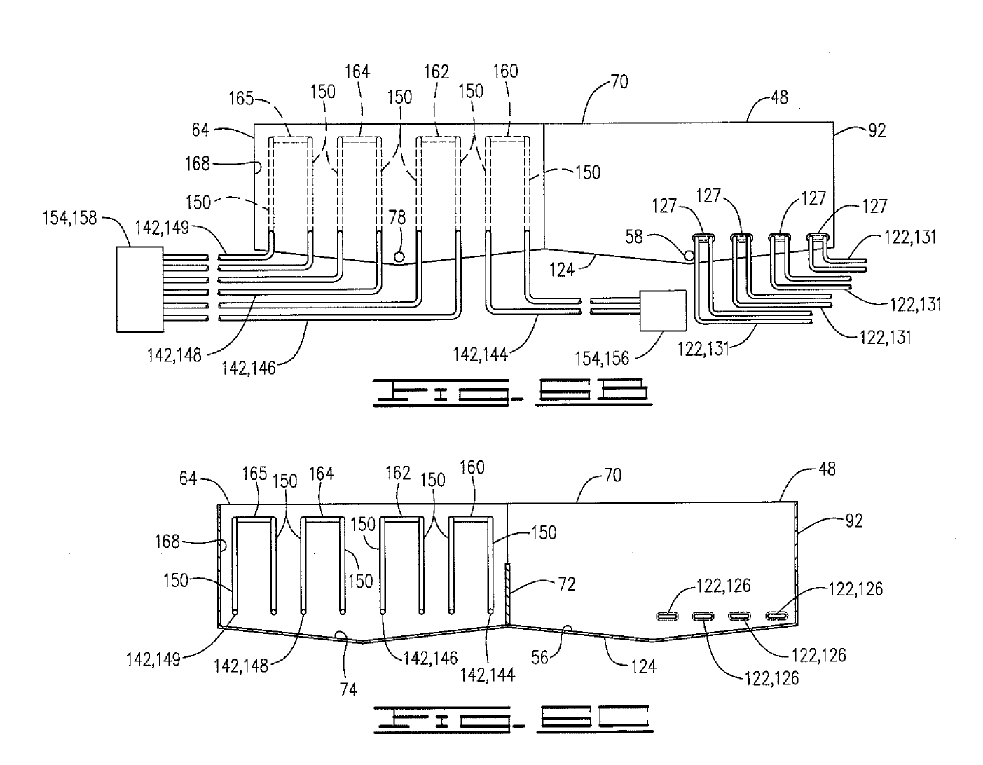

Regarding FIGS. 5A-7A, second chamber 64 has second heat exchanger system 142. Second heat exchanger system 142 has at least heat exchangers 144 and 146. In the preferred embodiment, second heat exchanger system 142 has at least heat exchangers 144, 146 and 148. Heat exchangers 144, 146 and 148 each have at least one condensation tube bank 150. Condensation tube bank 150 includes a continuous tube 152 that is in fluid communication with chiller system 154.

Second heat exchanger system 142 receives cooling from chiller system 154 for removing the heat. Chiller system 154 may be a single chilling system or a plurality of chilling systems. In the preferred embodiment, chiller system 154 includes a first chiller 156 operatively providing cooling for heat exchanger 144. Second chiller 158 provides cooling for heat exchangers 146 and 148, as well as additional units.

Preferably, second heat exchanger system 142 is a chilling system having the cooling capacity capable of lowering an interior surface 68 temperature of second chamber 64 to the ambient wet-bulb temperature. Preferably, the outer surface of continuous tube 152 of condensation tube bank 150 provides interior surface 68 for condensation. However, interior surface 68 is any surface area positioned within second chamber 64 that is capable of being chilled to the ambient wet-bulb temperature.

Preferably, second heat exchanger system 142 is suitable to chill to the ambient wet-bulb temperature for a variety of geographic locations having a broad temperature range. Second chamber 64 may be passively cooled, as long as the interior surface 68 temperature is at the ambient wet-bulb temperature. The ambient wet-bulb temperature is measured using a wet-bulb thermometer (not shown) at the location by condensation apparatus 10 for the particular day or time of operation.

The interior surface 68 temperature of second chamber 64 is cooler than the interior temperature of first chamber 48. Thus, a temperature differential exists between first chamber 48 and the interior surface 68. The temperature differential provides for the transfer of fog 54 between first chamber 48 and interior surface 68 of second chamber 64 by natural convective flow. The preferred temperature differential is between the interior temperature of first chamber 48, which is greater than the ambient wet-bulb temperature and less than the boiling temperature of the pre-treated water, or about 212° F. (100° C.), and interior surface 68 temperature of second chamber 64, which is the ambient wet-bulb temperature or less. For example, if first chamber 48 is heated to an interior temperature of about 140° F. (60° C.) and the ambient wet-bulb temperature is about 50° F. (10° C.), the temperature differential will be about 90° F. (32° C.) when interior surface 68 of second chamber 64 is cooled to a temperature of about 50° F. (10° C.).

Regarding FIGS. 5A-7A, heat exchanger 144 is positioned to be the first to receive fog 54. Heat exchanger 144 receives the initial heat load from fog 54. The heat exchange capacity of second heat exchanger system 142 with chiller system 154 is determined by the heat load on first condensation tube bank 160. In one embodiment, first condensation tube bank 160 of heat exchanger 144 is shown positioned between second chamber side walls 161, thereby maximizing interior surface 68 receiving fog 54. In this configuration, first condensation tube bank 160 receives the majority of the thermal energy from fog 54. FIGS. 5A-7A depict a representative example of four heat exchanger systems 142 and four heat exchanger systems 122. As shown in FIGS. 5A-7A, heat exchanger 144 is positioned to receive more thermal energy than condensation tube banks 162, 164 and 165 of heat exchangers 146, 148 and 149. Thus, heat exchanger 144 is in fluid communication with first chiller 156 as a standalone unit. Heat exchangers 146, 148 and 149 are in fluid communication with second chiller 158.

Referring to FIG. 5A-7A, heat exchangers 146, 148 and 149 are positioned adjacent to heat exchanger 144 to seamlessly receive portions of fog 54 that do not condense on heat exchanger 144. FIGS. 5A and 6A-6C depict heat exchangers 144, 146, 148 and 149 positioned linearly within second chamber 64. Heat exchangers 144, 146, 148 and 149 may be positioned in a variety of configurations within second chamber. A non-limiting example is having heat exchangers 144, 146, 148 and 149 intertwined within second chamber 64. Another non-limiting example has heat exchangers 144, 146, 148 and 149 aligned along the length of second chamber 64. Heat exchangers 144, 146, 148 and 149 all have interior surfaces 68 providing a surface area for maximizing the heat transfer process and condensation of fog 54.

Fog 54 condenses within second chamber 64 directly upon interior surfaces 68. Fog 54 may also condense along ceiling 166 and/or on interior walls 168. The condensate flows toward floor 74, where it pools as reclaimed water, and is removed through port 78. FIGS. 2 and 3 depict second chamber floor 74 having a slight slope. Port 78 is positioned near lowest point 170 of the slope of second chamber 64. Preferably, pump 76 is used to remove the reclaimed water. The reclaimed water is pumped to holding tank 80. The reclaimed water is substantially free of TDS.

FIGS. 2, 4A, 5A and 9 depict manhole 172 positioned on chamber top 82 and manhole 174 on chamber top 176. Manholes 172 and 174 provide interior access to first chamber 48 and second chamber 64. As shown, manholes 172 and 174 are about 3 feet (0.91 meters) by 3 feet (0.91 meters) in diameter, but the shape and size may be different as long as access the interior of first chamber 48 and second chamber 64 is available. Additionally, manholes 172 and 174 may also be positioned on anywhere on tops 82 and 176, as well as along any of the sides of condensation apparatus 10. The positioning of manholes 172 and 174 is determined by the need for access.

Preferably, condensation apparatus 10 is not pressurized, and operates at the ambient atmospheric pressure.

FIGS. 2-4A, 5A and 10 depict the dimensions of a portable condensation apparatus 10. In condensation apparatus 10, first chamber 48 has a width 178, a length 180 and a height 182. Second chamber 64 has a width 184, a length 186 and a height 188. A notional system's first chamber 48 has with a width 178 of about 88 inches (2.24 meters), a length 180 of about 40 feet (12.19 meters), and a height 182 of about 82 inches (2.08 meters). The notional system's second chamber 64 has with a width 184 of about 88 inches (2.24 meters), a length 186 of about 40 feet (12.19 meters), and a height 188 of about 82 inches (2.08 meters).

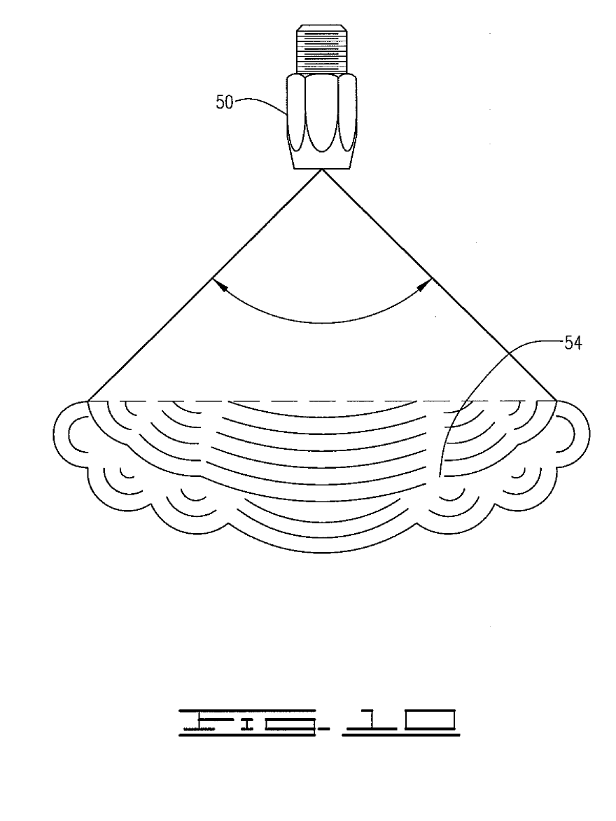

FIGS. 1 and 9 depict the condensation apparatus 10 as being a portable system. As a portable system, first chamber 48 and second chamber 64 are both mounted upon skid 190. Skid 190 is sized to operate on all U.S. roads and highways. Preferably, skid 190, first chamber 48 and second chamber 64, or vessel 70, form a single unit that is transportable. Thus, skid 190 has width 192 of about 102 inches (2.59 meters) or less. In one embodiment, skid 190 has width 192 of about 88 inches (2.24 meters) wide.

### Test Results

The condensation apparatus 10 utilized during testing was portable and had the dimensions identified in Table 1. The condensation apparatus 10 utilized a BETE model P fine atomization micronizer. Additionally, a Hutchinson Hayes Separation decanter centrifuge, model 5500, was used to separate the solids from the treatable water in the horizontal centrifuge. A Hutchinson Hayes Separation self-cleaning separator, Model SEA 1200 was used to separate the liquids from the treatable water in the vertical centrifuge. The operating conditions are identified in Table 2.

TABLE 1
Chamber Dimensions

| | Approx. Width | Approx. Length | Approx. Height |
|---|---|---|---|
| | (inches/meters) | (feet/meters) | (inches/meters) |
| First Chamber 48 | 60/1.52 | 10/3.05 | 60/1.52 |
| Second Chamber 64 | 60/1.52 | 10/3.05 | 60/1.52 |

The condensation apparatus 10 is demonstrated in the following experimental test results: All TDS were measured using a hand-held Hanna Meter No. H198130.

TABLE 2
Experimental Test Results

| | Test 1 | Test 2 | Test 3 | Test 4 |
|---|---|---|---|---|
| Water TDS input (ppm) | 30,000 | 243,000 | 15,000 | 370 |
| Water input pressure (psi)/(kilopascals) | 500/3447 | 450/3103 | 1000/6895 | 1000/6895 |
| First chamber temperature (° F.)/(° C.) | 150/66 | 150/66 | 150/66 | <150/66 |
| Second chamber temperature (° F.)/(° C.) - | ~ | 102/39 | 88/31 | 88/31 |
| Ambient Wet-Bulb Temperature | | | | |
| Water TDS output (ppm) | ~3,600 | 6,000 | 270 | 70 |
| Percent recovered | 88 | ~98 | ~98 | ~81 |
| Usable water yield (volume/hour) | >4 liters | >4 liters | ~86 barrels | ~86 barrels |

The results in Table 1 are from the small scale laboratory prototype for test 1 and test 2, and a portable field-sized prototype unit for test 3 and test 4. Test 4 shows that when the starting level of TDS is low, the percent of reclaimed water is lower. The increased pressure of the field unit operating with a first chamber temperature of about 150° F. (66° C.), or less, produced more than a 90% reduction of TDS when the starting TDS was at least 20,000 ppm.

Other embodiments of the current invention will be apparent to those skilled in the art from a consideration of this specification or practice of the invention disclosed herein. Thus, the foregoing specification is considered merely exemplary of the current invention with the true scope thereof being defined by the following claims.

What is claimed is:

1. A method for removing solids from water having a plurality of solid particles, wherein the solid particles include suspended solids and dissolved solids, the method comprising:
transferring the water to a first separator;
separating suspended solids from the water using said first separator;
transferring water from said first separator into a first chamber having an interior temperature greater than the ambient wet-bulb temperature of the surrounding environment and below the boiling temperature for the water, said first chamber being in fluid communication with a second chamber having a similar shape and size as said first chamber;
prior to or concurrently with the step of transferring the water from the first separator to the first chamber, reducing the particle size of the water particles such that the water particles have a mean particle size of about 100 microns or less; and
allowing substantially all of the dissolved solids in the water to separate from the water in the first chamber.

2. The method of claim 1, further comprising the step of separating a suspended liquid carried by the water using a second separator.

3. The method of claim 1, further comprising the step of heating said first chamber to an interior temperature between about 100° F. (37° C.) and about 150° F. (66° C.).

4. The method of claim 3, wherein said step of heating comprises using an indirect, self-contained heating system.

5. The method of claim 1, further comprising the step of heating said first chamber to an interior temperature between about 140° F. (60° C.) and about 150° F. (66° C.).

6. The method of claim 1, wherein the step of reducing said particle size of said water particles is accomplished by using a micronizer.

7. The method of claim 6, wherein said micronizer reduces said water particles to a mean size of about 50 microns or less.

8. The method of claim 1, wherein the step of reducing the water particles to a mean particle size creates a fog within said first chamber.

9. The method of claim 8, further comprising the step of cooling at least one interior surface within said second chamber to said ambient wet-bulb temperature of the surrounding environment.

10. The method of claim 9, wherein the step of cooling includes using a heat exchanger system, said heat exchanger providing a plurality of interior surfaces disposed within said second chamber.

11. The method of claim 9, further comprising a step of condensing said fog within said second chamber into a condensate, said second chamber being in fluid communication with said first chamber.

12. The method of claim 11, wherein said condensing step provides for collecting said condensate within said second chamber as a reclaimed water that is substantially free of dissolved solids.

13. A method of reclaiming a treatable water having dissolved solids, the method comprising the steps of:
providing a first chamber having an interior temperature greater than the ambient wet-bulb temperature of the surrounding environment and less than the boiling temperature of water, said first chamber being unpressurized;
providing a second chamber, said second chamber being in fluid communication with the first chamber and having a similar shape and size as the first chamber;—
cooling an interior surface positioned within said second chamber to the ambient wet-bulb temperature of the surrounding environment, said cooling step creating a temperature differential between the first chamber and the cooled interior surface;
injecting said treatable water into said first chamber, said treatable water carrying at least one dissolved solid;
prior to or concurrently with the step of injecting said treatable water into the first chamber, micronizing said treatable water to a water particle size having a micronized mean particle diameter of about 100 microns or less, wherein said step of micronizing separates said dissolved solid from said water particle and creates a fog of said micronized water particles in said first chamber;
transferring said fog from said first chamber to said second chamber;
condensing said fog into a condensate of a reclaimed water on said cooled interior surface within said second chamber;
collecting said reclaimed water within said second chamber; and
extracting said reclaimed water from said second chamber.

14. The method of claim 13, further comprising a step of heating said first chamber to an interior temperature between about 100° F. (37° C.) and about 150° F. (66° C.).

15. The method of claim 14, wherein said step of heating comprises using an indirect, self-contained heating system.

16. The apparatus of claim 14, wherein said step of heating increases said first chamber temperature to a temperature between about 140° F. (60° C.) and about 150° F. (66° C.).

17. The method of claim 13, further comprising a step of pressurizing said treatable water to a pressure of at least 1000 psi (6895 kilopascal), said step of pressurizing occurring prior to said step of injecting.

18. The method of claim 13, wherein said step of micronizing uses a plurality of micronizers.

19. The method of claim 13, wherein said step of micronizing reduces said micronized water particle to a mean diameter of about 50 microns or less.

20. The method of claim 13, wherein said step of micronizing removes up to 90% of said dissolved solids from said treatable water.

21. The method of claim 13, wherein said step of micronizing removes between about 40% to about 99% of said dissolved solids from said treatable water.

22. The method of claim 13, wherein said step of micronizing removes between about 80% to about 98% of said dissolved solids from said treatable water.

23. The method of claim 13, further comprising the step of pre-treating said water to remove at least one suspended solid from said treatable water.

24. A water reclamation apparatus comprising:
a first and a second chamber, said first and second chamber being in fluid communication with each other, wherein said first and second chambers are unpressurized and have a substantially similar shape and size;
a micronizer positioned within said first chamber, said micronizer being suitable for injecting the water into said first chamber and creating a fog in the first chamber; and
a heat exchanger system positioned within said second chamber and is suitable for condensing said fog transferred from said first chamber to said second chamber.

25. The apparatus of claim 24, further comprising a pressurization chamber, said pressurization chamber capable of providing said micronizer with water at a pressure of at least 1000 psi (6895 kilopascal).

26. The apparatus of claim 24, wherein said micronizer has a nozzle capable of producing a micronized particle of water having a mean diameter of about 100 microns or less.

27. The apparatus of claim 24, wherein said micronizer has a nozzle capable of producing a micronized particle of water having a mean diameter of about 50 microns or less.

28. The apparatus of claim 24, further comprising a plurality of micronizers.

29. The apparatus of claim 24, wherein said heat exchanger provides an interior surface within said second chamber, said heat exchanger being suitable to cool said interior surface to the ambient wet-bulb temperature of the surrounding environment.

30. The apparatus of claim 24, further comprising a heating system, said heating system suitable to heat said first chamber to an interior temperature between about 10° F. (37° C.) and about 150° F. (66° C.).

31. The apparatus of claim 30, wherein said heating system is a self-contained heating system suitable to indirectly heat said first chamber.

32. The apparatus of claim 30, wherein said heating system heats said first chamber so that said first chamber temperature is between about 140° F. (60° C.) and about 150° F. (66° C.).

33. The apparatus of claim 24, further comprising a skid, wherein said apparatus is mounted upon a single, transportable skid.

34. A portable water reclamation apparatus for water having dissolved solids comprising:
a skid;
a first and second chamber mounted upon said skid, said first and second chambers being unpressurized and having a substantially similar shape and size, wherein said second chamber is in fluid communication with said first chamber;
a plurality of injectors positioned within said first chamber and in fluid communication with said first chamber, said injectors providing water to said first chamber; and
a cooling system associated with said second chamber, said cooling system for operably cooling an interior surface of said second chamber to the ambient wet-bulb temperature of the surrounding environment.

35. The portable apparatus of claim 34, wherein said skid has a width of about 102 inches (2.59 meters) or less.

36. The apparatus of claim 34, further comprising a heating system, said heating system suitable to heat said first chamber to a first chamber temperature between about 100° F. (37° C.) and about 150° F. (66° C.).

37. The apparatus of claim 36, wherein said heating system heats said first chamber so that said first chamber temperature is between about 140° F. (60° C.) and about 150° F. (66° C.).

38. The apparatus of claim 36, wherein said heating system is an active heat source.

39. The apparatus of claim 36, wherein said heating system is a passive heat source.

40. The apparatus of claim 36, wherein said heating system is a self-contained heating system capable of indirectly heating said first chamber.

41. The portable apparatus of claim 34, wherein said injector includes at least one micronizer, said micronizer capable of receiving water at a pressure of at least 1000 psi (6895 kilopascal) and producing a micronized particle of water having a mean diameter of about 100 microns or less.

42. The portable apparatus of claim 41, wherein said micronizer produces a micronized particle of water having a mean diameter of about 50 microns or less.

43. An apparatus for removing dissolved solids from water comprising:
a first chamber;
a plurality of micronizers positioned on said first chamber, said micronizers being capable of injecting the water into said first chamber, wherein the water has at least one dissolved solid, and wherein said micronizers reduce the water to a micronized water particle having a mean diameter of about 100 microns or less;
a heating system, said heating system being operably associated with said first chamber, wherein said heating system is suitable for increasing an interior temperature of said first chamber to greater than the ambient wet-bulb temperature of the surrounding environment and less than the boiling temperature of water;
a second chamber, said second chamber having a substantially similar shape and size as said first chamber, and said second chamber being in fluid communication with said first chamber; and
a cooling system, said cooling system being operably associated with said second chamber, wherein said cooling system suitable for cooling an interior surface within said second chamber to the ambient wet-bulb temperature of the surrounding environment.

44. The apparatus of claim 43, wherein said micronizers receive water at a pressure of at least 1000 psi (6895 kilopascal).

45. The apparatus of claim 43, wherein said heating system heats said first chamber temperature to between about 100° F. (37° C.) and about 150° F. (66° C.).

46. The portable apparatus of claim 43, wherein said micronizers produce a micronized particle of water having a mean diameter of about 50 microns or less.

47. The apparatus of claim 43, wherein said heating system is a self-contained heating system suitable to indirectly beat said first chamber.
